(19) United States
(12) Patent Application Publication
(10) Pub. No.: US 2002/0087417 A1
(43) Pub. Date: Jul. 4, 2002

(54) System, method and storage medium recording thereon program for forwarding printed matters

(75) Inventor: Koichi Sawada, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/026,428

(22) Filed: Dec. 27, 2001

(30) Foreign Application Priority Data
Dec. 28, 2000 (JP) 2000-401582

(51) Int. Cl. G06F 17/60

(52) U.S. Cl. 705/24

(57) ABSTRACT

It is enabled to easily consign forwarding of printed matters without requiring the addition of any special function other than an electronic mail environment. The consignor transmits a request for forwarding a printed matter as an electronic mail to a destination stated in a manner in which the domicile address and name of the destination and a forwarding consignee electronic mail server are combined in accordance with a certain rule. This enables the forwarding consignee electronic mail server to identify, in accordance with the rule, the domicile address from the destination statement of the electronic mail, take out the text of the electronic mail, print out the domicile address and name of the destination and the text into a printed matter, and forward it to its identified destination.

### BACKGROUND OF THE INVENTION

1. Field of the Invention

The present invention relates to a system, a method and a storage medium recording thereon a program for forwarding printed matters enabling a consignor to consign the forwarding of printed matters over the Internet.

2. Description of the Related Art

Existing printed matter forwarding services using the Internet include Hybrid Mail (http://www.hybridmail.go.jp/) provided by the Ministry of Public Management, Home Affairs, Posts and Telecommunications of Japan, and BIGLOBE Computer Mail (http://index.biglobe.ne.jp/personal/index.html) provided by NEC Corporation.

However, these existing printed matter forwarding services using the Internet cannot be used unless some special function is added to the environment usually used by the consignor or a complex procedure is gone through on WWW, and accordingly permits no easy utilization.

### SUMMARY OF THE INVENTION

An object of the present invention, attempted to solve this problem, is to provide a system, a method and a storage medium recording thereon a program for forwarding printed matters, which require the addition of no special function other than an electronic mail environment and thereby contribute to simplified consignment of the forwarding of printed matters.

According to an aspect of the present invention, there is provided a system for forwarding printed matters comprising: an electronic mail analyzing means for receiving electronic mail and identifying the destination thereof from its destination statement; and a printed matter preparing means for preparing a printed matter on which is printed information on the destination identified by the electronic mail analyzing means.

According to another aspect of the invention, there is provided a system for forwarding printed matters comprising: an electronic mail analyzing means for receiving electronic mail, identifying the destination thereof from its destination statement and taking out the text thereof; and a printed matter preparing means for preparing a printed matter on which are printed information on the destination identified by the electronic mail analyzing means and the text taken out by the electronic mail analyzing means.

According to still another aspect of the invention, there is provided a version of the above-described system wherein the electronic mail analyzing means may identify the originating source of the electronic mail, and the printed matter preparing means might then prepare a printed matter on which is further printed information on the originating source identified by the electronic mail analyzing means. The electronic mail analyzing means may identify the originating source of the electronic mail, and the system may be further provided with a billing information preparing means for preparing information required for billing the originating source identified by the electronic mail analyzing means.

According to still another aspect of the invention, there is provided a system for forwarding printed matters comprising: an electronic mail analyzing means for receiving an electronic mail and identifying the destination thereof from its destination statement; and a print instructing means for handing over information on the destination identified by the electronic mail analyzing means to another printed matter forwarding system.

According to still another aspect of the invention, there is provided a system for forwarding printed matters comprising: an electronic mail analyzing means for receiving an electronic mail, identifying the destination thereof from its destination statement and taking out the text thereof; and a print instructing means for handing over information on the destination identified by the electronic mail analyzing means and the text taken out by the electronic mail analyzing means to another printed matter forwarding system.

According to still another aspect of the invention, there is provided a version of the above-described system wherein the electronic mail analyzing means may identify the originating source of the electronic mail, and the print instructing means may hand over information on the originating source identified by the electronic mail analyzing means to the other printed matter forwarding system. The electronic mail analyzing means may identify the originating source of the electronic mail, and the system may be further provided with a billing information preparing means for preparing information required for billing the originating source identified by the electronic mail analyzing means.

According to still another aspect of the present invention, there is provided a method for forwarding printed matters, comprising: a first step of receiving an electronic mail; a second step of identifying the originating source of the electronic mail received at the first step; a third step of identifying the destination of the electronic mail received at the first step from its destination statement; a fourth step of acquiring the text of the electronic mail received at the first step; a fifth step of giving an instruction to print information on the destination identified at the third step and the text acquired at the fourth step; and a sixth step of preparing information required for billing the originating source identified at the second step.

According to still another aspect of the present invention, there is provided a method for forwarding printed matters, comprising: a first step of receiving an electronic mail; a second step of identifying the originating source of the electronic mail received at the first step; a third step of identifying the destination of the electronic mail received at the first step from its destination statement; a fourth step of acquiring the text of the electronic mail received at the first step; a fifth step of giving an instruction to print information on the originating source identified at the second step, information on the destination identified at the third step and the text acquired at the fourth step; and a sixth step of preparing information required billing the originating source identified at the second step.

According to still another aspect of the present invention, there is provided, a storage medium recording thereon a program enabling a computer to execute: first processing to receive an electronic mail; second processing to identify the originating source of the electronic mail identified by the first processing; third processing to identify the destination of the electronic mail received by the first processing from its destination statement; fourth processing to acquire the text of the electronic mail received by the first processing; fifth processing to give an instruction to print information on the destination identified by the third processing and the text acquired by the fourth processing; and sixth processing to prepare information required for billing the originating source identified by the second processing.

According to still another aspect of the present invention, there is provided, a storage medium recording thereon a program enabling a computer to execute: first processing to receive an electronic mail; second processing to identify the originating source of the electronic mail identified by the first processing; third processing to identify the destination of the electronic mail received by the first processing from its destination statement; fourth processing to acquire the text of the electronic mail received by the first processing; fifth processing to give an instruction to print the originating source identified by the second processing, information on the destination identified by the third processing and the text acquired by the fourth processing; and sixth processing to prepare information required for billing the originating source identified by the second processing.

According to still another aspect of the present invention, there is provided storage medium group in which the aforementioned program is divided and each divided segment is recorded on one or another of a plurality of storage media.

### BRIEF DESCRIPTION OF THE DRAWINGS

Other features and advantages of the invention will become more apparent from the following detailed description when taken in conjunction with the accompanying drawings, wherein:

FIG. 1 is a flow chart illustrating the overall configuration of a preferred embodiment of the invention;

FIG. 2 illustrates the configuration of a forwarding consignee electronic mail server 20 in the embodiment of the invention;

FIG. 3 is a flow chart showing the overall operation of the embodiment of the invention; and

FIG. 4 is a flow chart showing the operation of the forwarding consignee electronic mail server 20 in the embodiment of the invention.

### DETAILED DESCRIPTION OF THE PREFERRED EMBODIMENT

Next will be described in detail a preferred embodiment of the present invention with reference to the accompanying drawings.

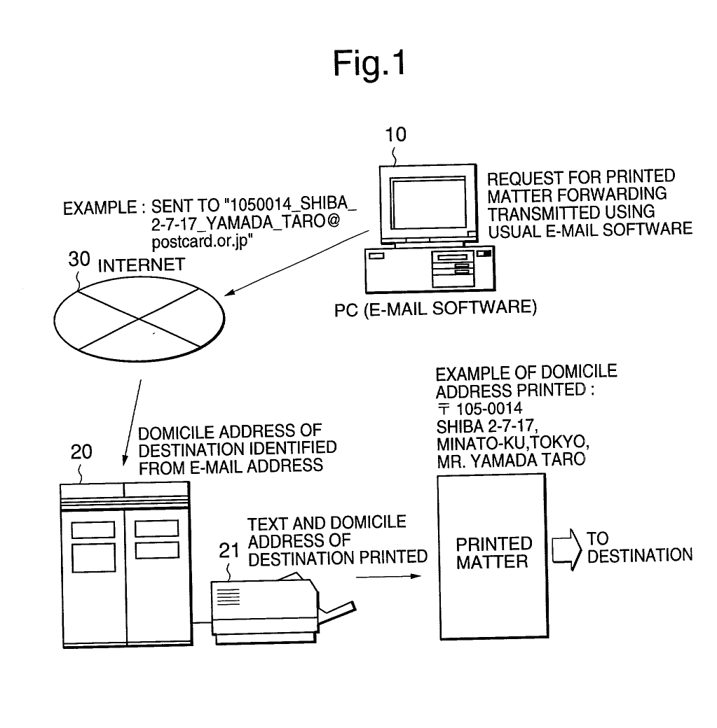

Referring to FIG. 1, this embodiment of the invention comprises a user terminal 10 such as a personal computer (PC) or the like and a server computer 20 connected via a computer network 30 such as the Internet. The user terminal 10 here is required to have at least an electronic mail environment (electronic mail software installed therein), and a number of such terminals matching the number of users are supposed to be provided. The server computer 20 is an electronic mail server for accepting forwarding consignments from users, and will hereinafter be referred to as the forwarding consignee electronic mail server. To the forwarding consignee electronic mail server 20 is connected a printer 21 for preparing printed matters.

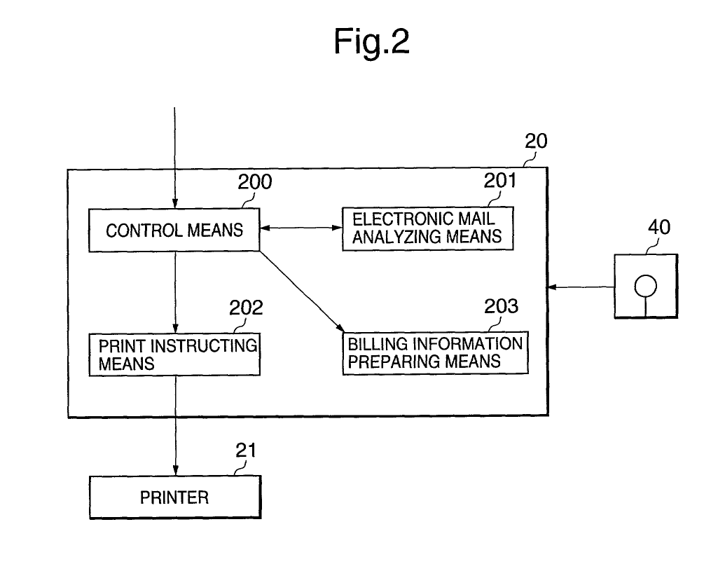

Referring to FIG. 2, the forwarding consignee electronic mail server 20 is provided with a control means 200, an electronic mail analyzing means 201, a print instructing means 202 and a billing information preparing means 203. The control means 200 receives electronic mails transmitted over the Internet and controls the actions of the other means. The electronic mail analyzing means 201 analyzes electronic mails to acquire information on the destination, text and so forth of each; the print instructing means 202 gives the printer 21 print instructions on the basis of the information on destinations, texts and so forth; and the billing information preparing means 203 prepares information required for billing forwarding consignors.

Incidentally, each of the control means 200, the electronic mail analyzing means 201, the print instructing means 202 and the billing information preparing means 203 is realized in a computer program read out by the CPU of the forwarding consignee electronic mail server 20, and this computer program may be loaded from a storage medium 40. The storage medium 40 here may be a magnetic disk, a semiconductor memory or any other suitable storage medium, and the program may be split for divided storage in a storage medium group consisting of a plurality of storage media.

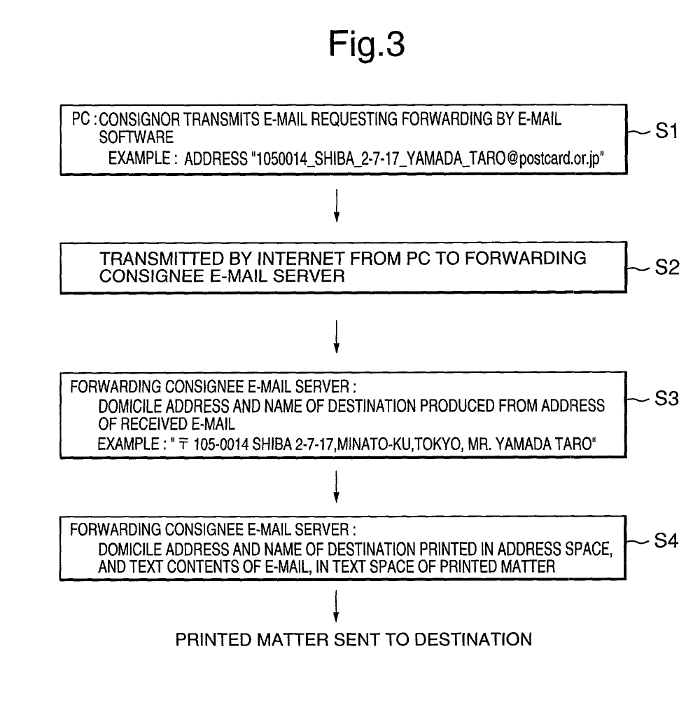

Next will be outlined, with reference to FIG. 3, the operation of this embodiment of the invention.

First, in order to consign forwarding of a printed matter by this system, the prospective consignor has to register itself as a member. Once registered, information on the consignor is stored in, for instance the billing information storage area (not shown) of the forwarding consignee electronic mail server 20. At this point, however, no billing information regarding the consignor is existent. The consignor transmits its request for forwarding of a printed matter by electronic mail (step S1) . The destination statement of the electronic mail may be, for instance, a combination of the domicile address and name of the destination and the forwarding consignee electronic mail server, such as “domicile address and name of destination @ the domain name of the forwarding consignee electronic mail server.” The text of the electronic mail shall be the desired content of the printed matter. The destination statement of the electronic mail should be readily inferable by the consignor from the domicile address and name of the destination according to a predetermined rule (for instance, 1050014_Shiba_{—}2_{—}7_{—}7_Yamada_Taro@postcard.or.jp, the rule applicable to which is “ZIP code”+“_”+“domicile address”+“_”+“family name”+“_”+“given name”+“@postcard. or. jp”).

The electronic mail requesting the forwarding is sent to the forwarding consignee electronic mail server 20 via the Internet (step S2). The forwarding consignee electronic mail server 20 having received the electronic mail, instead of processing it in the usual manner of processing by an electronic mail server, takes out the domicile address of the destination and the text of the electronic mail from the destination statement and text of the electronic mail (step S3), and prints them with the printer (step S4).

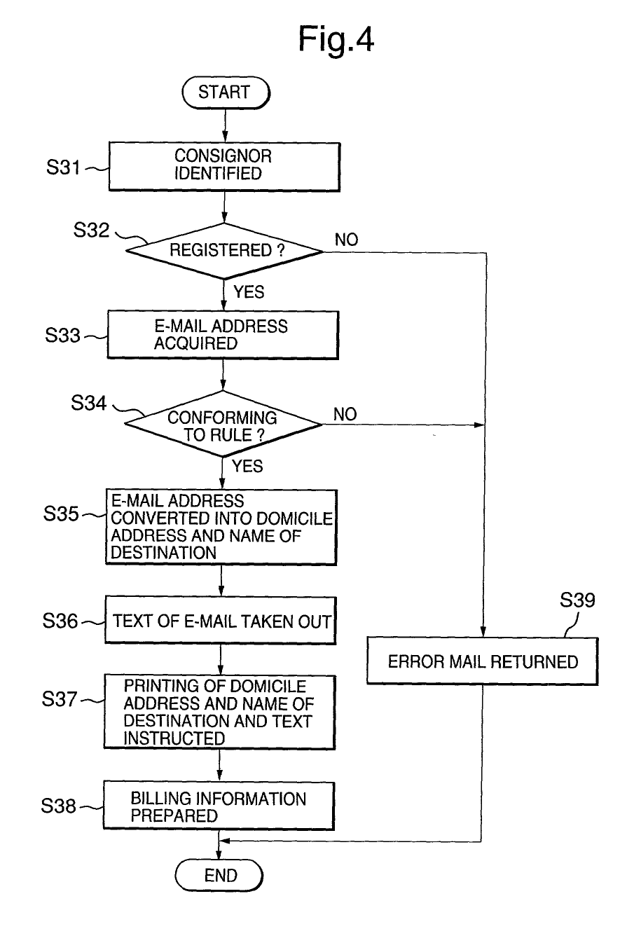

Now will be described in further detail, with reference to FIG. 4, the processing of steps S3 and S4 carried out by the forwarding consignee electronic mail server 20. First, when the control means 200 of the forwarding consignee electronic mail server 20 receives the electronic mail, it instructs the electronic mail analyzing means 201 to analyze this electronic mail, and the electronic mail analyzing means 201 identifies the consignor on the basis of this electronic mail (step S31). Available methods of identifying the consignor include, for instance, deciphering of an encrypted signature stated on the electronic mail and, if the electronic mail is sent via a provider, determination on the basis of authentication information sent from the provider, but the invention is not confined to any specific method as long as the consignor can be identified.

The electronic mail analyzing means 201 here judges whether or not the consignor is already registered as a member and stored in the billing information storage area (step S32) and, if not, returns an error mail (step S39).

Next, the electronic mail analyzing means 201 of the forwarding consignee electronic mail server 20 acquires the destination statement of this electronic mail (step S33). The electronic mail analyzing means 201 determines here whether or not the destination statement conforms to the predetermined rule (step S34) and, if not, returns an error mail (step S39) Or if it does conform, the electronic mail analyzing means 201 converts this destination statement into the domicile address and name of the destination (step S35). If, for instance, the destination statement is expressed in accordance with the rule of “ZIP code”+“_”+“domicile address”+“_”+“family name”+“_”+“given name”+“@postcard.or.jp” and a destination of 1050014_Shiba_{—}2_{—}7_{—}7_Yamada_Taro@postcard.or.jp is set, the domicile address of the destination will be “Shiba 2_{—}7_{—}17, [symbol] 1050014” and the name of the destination, “Yamada Taro.” As the ZIP code reveals that the domicile address of this destination is in Minato Ward, Tokyo, the domicile address of the destination may as well be stated as “ [symbol] 1050014, Shiba 2_{—}7_{—}17, Minato-ku, Tokyo” as shown in the flow chart.

Incidentally, the rule to be used here may either be directly stated in the computer program for realizing the electronic mail analyzing means 201 or be stored in a storage area (not shown) of the forwarding consignee electronic mail server 20 to be read out by the computer program as required.

Then, the electronic mail analyzing means 201 acquires the text from the electronic mail (step S36), and returns these acquired items of information (the domicile address and name of the destination and the text) to the control means 200.

The control means 200 hands over these items of information to the print instructing means 202. The print instructing means 202, on the basis of these items of information, gives a print instruction to the printer 21 (step S36). This causes the printer 21 to prepare a printed matter for the destination using a known printing technique. Thus, it prepares a printed matter in which the domicile address and name of the destination taken out of the electronic mail are printed in the destination statement space and the text content of the electronic mail in the text space.

Finally, the control means 200 instructs the billing information preparing means 203 to prepare billing information, and the billing information preparing means 203 prepares billing information with respect to that particular consignor (step 38). This makes is possible to bill, using any known method, the consignor for the charge of the forwarding service.

While the foregoing description supposes that this embodiment of the invention is supposed to carry out processing in the procedure charted in FIG. 4, it is not confined to this procedure, but the processing can be done in any other procedure as long as it does not deviate from the feature that the domicile address and name of the destination and the text are taken out of the destination statement of the electronic mail and prepared into a printed matter.

Also, while the foregoing description supposes that this embodiment is to print only the domicile address and name of the destination and the text, it can also be made possible to print the name of the consignor identified at step S31 as well. Or if, at the time of membership registration, the domicile address is also stored matched to the consignor when, for instance, consignor information is stored in the billing information storage area, identification of the consignor would automatically result in identification of its domicile address as well, and accordingly the consignor's domicile address can also be printed.

Further, it is also possible to let the forwarding consignee electronic mail server 20 not immediately print the printed matter as soon as it has become printable, instead store information on the printed matter and print it at a specified subsequent time. In this way, the storage space for the printed matter can be dispensed with, and if the printed matter is required to be forwarded at a specified time, the requirement can be easily met. It is also conceivable to instruct the forwarding of the printed matter by tying up with an existing mail forwarding system, such as Hybrid Mail of the Ministry of Public Management, Home Affairs, Posts and Telecommunications, and handing over the printed matter information stored as described above to the system.

It is also possible to increase the efficiency and speed of printed matter forwarding by making ready a plurality of forwarding consignee electronic mail servers 20, one for each destination area and installing each of the forwarding consignee electronic mail servers 20 in a suitable location for the destinations covered.

As hitherto described, this embodiment of the invention causes the forwarding consignee electronic mail server to print the domicile address and name of the destination produced from the destination statement of the electronic mail as the destination statement of the printed matter and the text content of the electronic mail as the text of the printed matter. This configuration enables the forwarding of printed matters to be consigned in exactly the same procedure as the procedure for electronic mailing, which is the most popular means of communication for users of the Internet. Thus, this embodiment of the invention has the advantage of making possible communication of information to parties who cannot or do not use electronic mails and consignment of printed matter forwarding without having to add any special function besides an electronic mail environment.

What is claimed is:

1. A system for forwarding printed matters, comprising:
an electronic mail analyzing means for receiving an electronic mail and identifying the destination thereof from its destination statement; and
a printed matter preparing means for preparing a printed matter on which is printed information on the destination identified by said electronic mail analyzing means.

2. A system for forwarding printed matters, comprising:
an electronic mail analyzing means for receiving electronic mail, identifying the destination thereof from its destination statement and taking out the text thereof; and
a printed matter preparing means for preparing a printed matter on which are printed information on the destination identified by said electronic mail analyzing means and the text taken out by said electronic mail analyzing means.

3. The system, as claimed in claim 1, wherein:
said electronic mail analyzing means identifies the originating source of said electronic mail, and
said printed matter preparing means prepares a printed matter on which is further printed information on the originating source identified by said electronic mail analyzing means.

4. The system, as claimed in claim 1, wherein:
said electronic mail analyzing means identifies the originating source of said electronic mail; and the system further includes:
a billing information preparing means for preparing information required for billing the originating source identified by said electronic mail analyzing means.

5. A system for forwarding printed matters, comprising:
an electronic mail analyzing means for receiving an electronic mail and identifying the destination thereof from its destination statement; and
a print instructing means for handing over information on the destination identified by said electronic mail analyzing means to another printed matter forwarding system.

6. A system for forwarding printed matters comprising:
an electronic mail analyzing means for receiving an electronic mail, identifying the destination thereof from its destination statement and taking out the text thereof; and
a print instructing means for handing over information on the destination identified by said electronic mail analyzing means and the text taken out by said electronic mail analyzing means to another printed matter forwarding system.

7. The system, as claimed in claim 5, wherein:
said electronic mail analyzing means identifies the originating source of said electronic mail, and
said print instructing means hands over information on the originating source identified by said electronic mail analyzing means to said other printed matter forwarding system.

8. The system, as claimed in claim 5, wherein:
said electronic mail analyzing means identifies the originating source of said electronic mail; and the system further includes:
a billing information preparing means for preparing information required for billing the originating source identified by said electronic mail analyzing means.

9. A method for forwarding printed matters, comprising:
a first step of receiving an electronic mail;
a second step of identifying the originating source of the electronic mail received at said first step;
a third step of identifying the destination of the electronic mail received at said first step from its destination statement;
a fourth step of acquiring the test of the electronic mail received at said first step;
a fifth step of giving an instruction to print information on the destination identified at said third step and the text acquired at said fourth step; and
a sixth step of preparing information required for billing the originating source identified at said second step.

10. A method for forwarding printed matters, comprising:
a first step of receiving an electronic mail;
a second step of identifying the originating source of the electronic mail received at said first step;
a third step of identifying the destination of the electronic mail received at said first step from its destination statement;
a fourth step of acquiring the text of the electronic mail received at said first step;
a fifth step of giving an instruction to print information on the originating source identified at said second step, information on the destination identified at said third step and the text acquired at said fourth step; and
a sixth step of preparing information required for billing the originating source identified at said second step.

11. A storage medium recording there on a program enabling a computer to execute:
first processing to receive an electronic mail;
second processing to identify the originating source of the electronic mail identified by said first processing;
third processing to identify the destination of the electronic mail received by said first processing from its destination statement;
fourth processing to acquire the text of the electronic mail received by said first processing;
fifth processing to give an instruction to print information on the destination identified by said third processing and the text acquired by said fourth processing; and
sixth processing to prepare information required for billing the originating source identified by said second processing.

12. A storage medium recording thereon a program enabling a computer to execute:
first processing to receive an electronic mail;
second processing to identify the originating source of the electronic mail identified by said first processing;
third processing to identify the destination of the electronic mail received by said first processing from its destination statement;
fourth processing to acquire the text of the electronic mail received by said first processing;
fifth processing to give an instruction to print information on the originating source identified by said second processing, information on the destination identified by said third processing and the text acquired by said fourth processing; and
sixth processing to prepare information required for billing the originating source identified by said second processing.

13. A storage medium group in which said program claimed in claim 11 is divided and each divided segment is recorded on one or another of a plurality of storage media.

14. A program embodied in electrical signals, said program enabling a computer to execute:
first processing to receive an electronic mail;
second processing to identify the originating source of the electronic mail identified by said first processing;
third processing to identify the destination of the electronic mail received by said first processing from its destination statement;
fourth processing to acquire the text of the electronic mail received by said first processing;
fifth processing to give an instruction to print information on the destination identified by said third processing and the text acquired by said fourth processing; and
sixth processing to prepare information required for billing the originating source identified by said second processing.

15. A program embodied in electrical signals, said program enabling a computer to execute:
first processing to receive an electronic mail;
second processing to identify the originating source of the electronic mail identified by said first processing;
third processing to identify the destination of the electronic mail received by said first processing from its destination statement;
fourth processing to acquire the text of the electronic mail received by said first processing;
fifth processing to give an instruction to print information on the originating source identified by said second processing, information on the destination identified by said third processing and the text acquired by said fourth processing; and
sixth processing to prepare information required for billing the originating source identified by said second processing.
